(19) United States
(12) Patent Application Publication
(10) Pub. No.: US 2025/0207614 A1
(43) Pub. Date: Jun. 26, 2025

(54) PRESSURE EXCHANGER FLOW ADAPTER

(71) Applicant: Energy Recovery, Inc., San Leandro, CA (US)

(72) Inventors: Alexander Patrick Theodossiou, Alameda, CA (US); Chinmay Vishwas Deshpande, Fremont, CA (US); Omprakash Samudrala, San Ramon, CA (US); Matthew Joseph Pattom, Fremont, CA (US)

(21) Appl. No.: 18/849,444

(22) PCT Filed: Mar. 24, 2023
(86) PCT No.: PCT/US2023/016293

§ 371 Date: Sep. 20, 2024

Related U.S. Application Data
(60) Provisional application No. 63/323,462, filed on Mar. 24, 2022.

(51) Int. Cl. F04F 13/00

(52) U.S. Cl. CPC F04F 13/00

(57) ABSTRACT

A pressure exchanger includes a rotor, an end cover, and a flow adapter. The rotor is configured to exchange pressure between fluids. The end cover is disposed at a distal end of the rotor. The end cover forms end cover low pressure ports and end cover high pressure ports. The flow adapter includes a planar surface, a distal end, and a upper surface. The planar surface forms planar low pressure openings and planar high pressure openings and is configured to seal to the end cover. The distal end forms a distal low pressure opening. Low pressure fluid flow is between the end cover low pressure ports and the distal low pressure opening via the planar low pressure openings. The upper surface forms upper high pressure openings. High pressure fluid flow is between the end cover high pressure ports and the upper high pressure openings via the planar high pressure openings.

### RELATED APPLICATIONS

This is a national stage application under 35 U.S.C. 371 of International Application PCT/US23/16293, filed Mar. 24, 2023, which claims benefit of U.S. Provisional Application No. 63/323,462, filed Mar. 24, 2022, the contents of which are incorporated by reference in their entirety.

### TECHNICAL FIELD

The present disclosure relates to pressure exchangers, and, more particularly, flow adapters of pressure exchangers.

### BACKGROUND

Systems use fluids at different pressures. Systems use components to increase pressure of fluid.

### BRIEF DESCRIPTION OF THE DRAWINGS

The present disclosure is illustrated by way of example, and not by way of limitation in the figures of the accompanying drawings.

FIGS. 1A-D illustrate schematic diagrams of fluid handling systems including hydraulic energy transfer systems, according to certain embodiments.

FIGS. 2A-E are exploded perspective views of pressure exchangers (PXs), according to certain embodiments.

FIGS. 3A-N illustrate components of PXs, according to certain embodiments.

FIG. 4 is a flow diagram illustrating a method associated with control of pressure in a pressure exchanger, according to some embodiments.

FIG. 5 is a block diagram illustrating a computer system, according to certain embodiments.

### DETAILED DESCRIPTION OF EMBODIMENTS

Embodiments described herein are related to pressure exchanger flow adapters.

Systems may use fluids at different pressures. A supply of a fluid to a system may be at lower pressure and one or more portions of the system may operate at higher pressures. A system may include a closed loop with various fluid pressures maintained in different portions of the loop. These systems may include hydraulic fracturing (e.g., fracking or fracing) systems, desalinization systems, refrigeration systems, heat pump systems, energy generation systems, mud pumping systems, slurry pumping systems, industrial fluid systems, waste fluid systems, fluid transportation systems, etc. Pumps or compressors may be used to increase pressure of fluids of such systems.

Conventionally, systems (e.g., refrigeration systems, heat pump systems, reversible heat pump systems, water systems, or the like) use pumps or compressors to increase the pressure of a fluid (e.g., a refrigeration fluid such as carbon dioxide (CO₂), R-744, R-134a, hydrocarbons, hydrofluorocarbons (HFCs), hydrochlorofluorocarbons (HCFCs), ammonia (NH₃), refrigerant blends, R-407A, R-404A, etc.). Conventionally, separate pumps or compressors mechanically coupled to motors are used to increase pressure of the fluid in any portion of a system including an increase in fluid pressure. Pumps and compressors, especially those that operate over a large pressure differential (e.g., cause a large pressure increase in the fluid), require large quantities of energy. Conventional systems thus expend large amounts of energy increasing the pressure of the fluid (via the pumps or compressors driven by the motors). Additionally, conventional fluid transfer systems decrease the pressure of the fluid through expansion valves. Conventional systems inefficiently increase pressure of fluid and decrease pressure of the fluid when operating in a loop. This is wasteful in terms of energy used to run the conventional systems (e.g., energy used to repeatedly increase the pressure of the refrigeration fluid to cause increase or decrease of temperature of the surrounding environment).

Conventionally, systems (e.g., refrigeration systems, heat pump systems, reversible heat pump systems, water systems, or the like) have components that are large and undergo bore machining processes in specific locations on the components. The bores take up a lot of spaces on the components and limit the types of applications where the components can be used. These conventional components waste material, have limited applications, take more time to produce, and the like.

The systems, devices, and methods of the present disclosure provide solutions to these and other shortcomings of conventional systems. The present disclosure provides PXs for use in systems (e.g., fluid handling systems, heat transfer systems, refrigeration systems, heat pump systems, cooling systems, heating systems, etc.). In a system, a PX may include a rotor and end covers disposed at distal ends of the rotor. The rotor is configured to exchange pressure between a first fluid (e.g., a high pressure portion of a refrigeration fluid in a refrigeration cycle) and a second fluid (e.g., a low pressure portion of the refrigeration fluid in the refrigeration cycle). The PX may receive the first fluid (e.g., a portion of the refrigeration fluid at high pressure) via a first inlet (e.g., a high pressure inlet) and a second fluid (e.g., a portion of the refrigeration fluid at a low pressure) via a second inlet (e.g., a low pressure inlet). When entering the PX, the first fluid may be of a higher pressure than the second fluid. The PX may exchange pressure between the first fluid and the second fluid. The first fluid may exit the PX via a first outlet (e.g., a low pressure outlet) and the second fluid may exit the PX via a second outlet (e.g., a high pressure outlet). When exiting the PX, the second fluid may have a higher pressure than the first fluid (e.g., pressure has been exchanged between the first fluid and the second fluid).

In some embodiments, a PX further includes a flow adapter. The flow adapter may include a planar surface (e.g., bottom surface that is to abut an upper surface of the end cover), a distal end (e.g., opposite the planar surface), and upper surfaces. The planar surface forms planar low pressure openings and planar high pressure openings. In some embodiments, face seals are to be disposed between the planar surface and the end cover to seal the flow adapter to the end cover. In some embodiments, radial seals are used to seal the flow adapter (e.g., to end cover, sleeve, housing, etc.). The end cover may form at least two end cover low pressure ports and at least two end cover high pressure ports. The distal end of the flow adapter may form a distal low pressure opening. Low pressure fluid flow is to be between the end cover low pressure ports and the distal low pressure opening via the planar low pressure openings. The upper surface of the flow adapter forms upper high pressure openings. High pressure fluid flow is between the end cover high pressure ports and the upper high pressure openings via the planar high pressure openings.

Systems, devices, and methods of the present disclosure provide advantages over conventional solutions. Systems of the present disclosure reduce energy consumption compared to conventional systems. For example, use of a PX of the present disclosure may recover energy stored as pressure and transfer that energy back into the system, reducing the energy cost of operating the system. Systems of the present disclosure may reduce wear on components (e.g., pumps, compressors) compared to conventional systems. A PX of the present disclosure may waste less material (e.g., by not having bores), may take less time to produce, may have more applications, and/or the like compared to conventional systems.

Although some embodiments of the present disclosure are described in relation to pressure exchangers, energy recovery devices, and hydraulic energy transfer systems, the current disclosure can be applied to other systems and devices (e.g., pressure exchanger that is not isobaric, rotating components that are not a pressure exchanger, a pressure exchanger that is not rotary, systems that do not include pressure exchangers, etc.).

Although some embodiments of the present disclosure are described in relation to exchanging pressure between fluid used in fracing systems, desalinization systems, heat pump systems, and/or refrigeration systems, the present disclosure can be applied to other types of systems. Fluids can refer to liquid, gas, transcritical fluid, supercritical fluid, subcritical fluid, and/or combinations thereof.

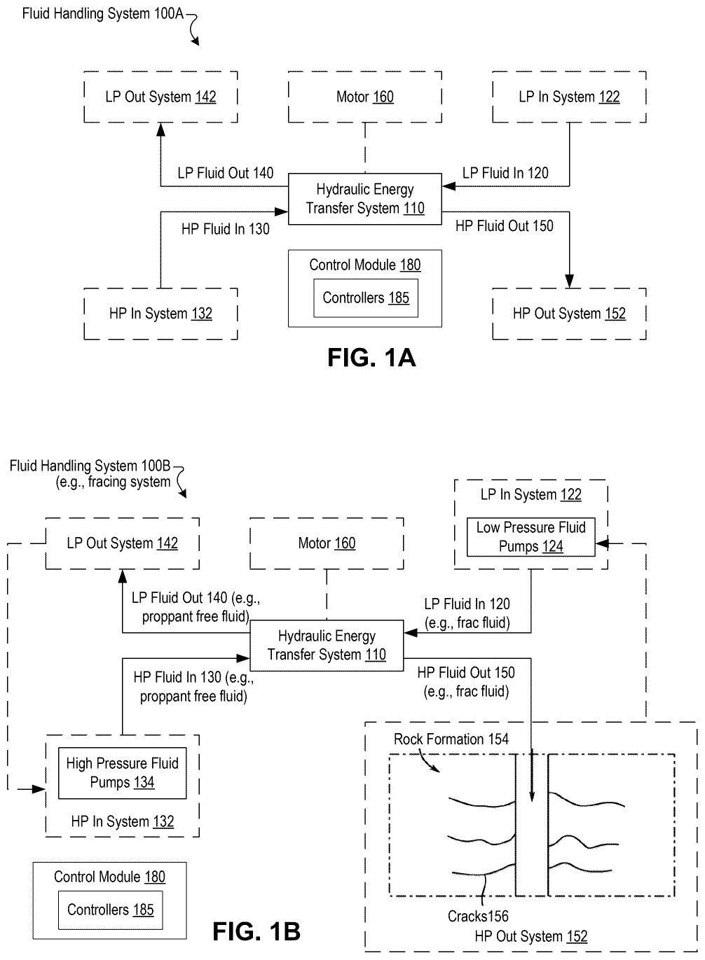

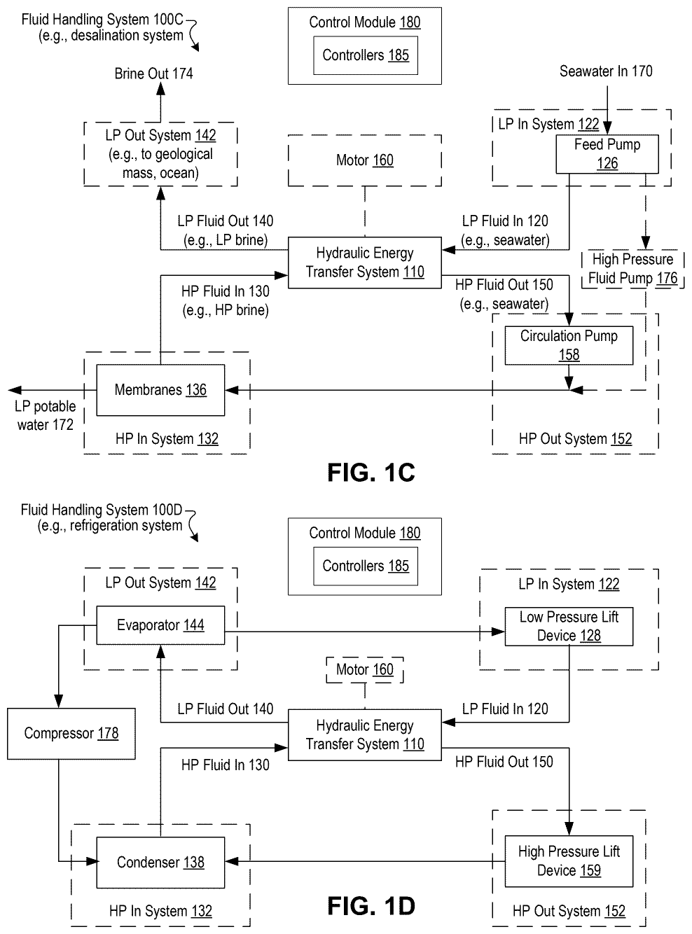

FIGS. 1A-D illustrate schematic diagrams of fluid handling systems 100 including hydraulic energy transfer systems 110, according to certain embodiments.

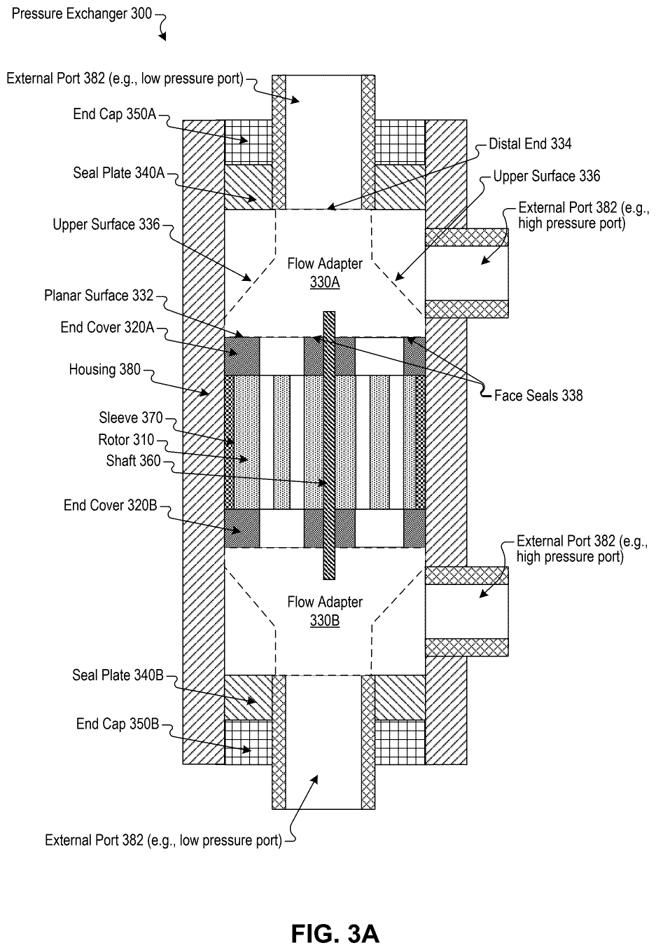

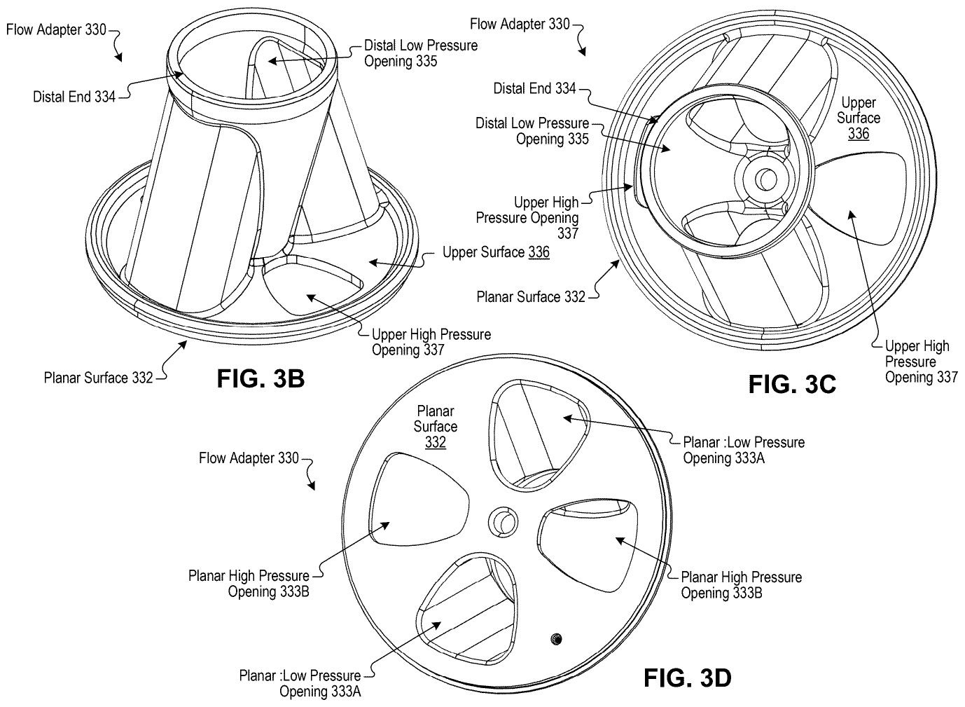

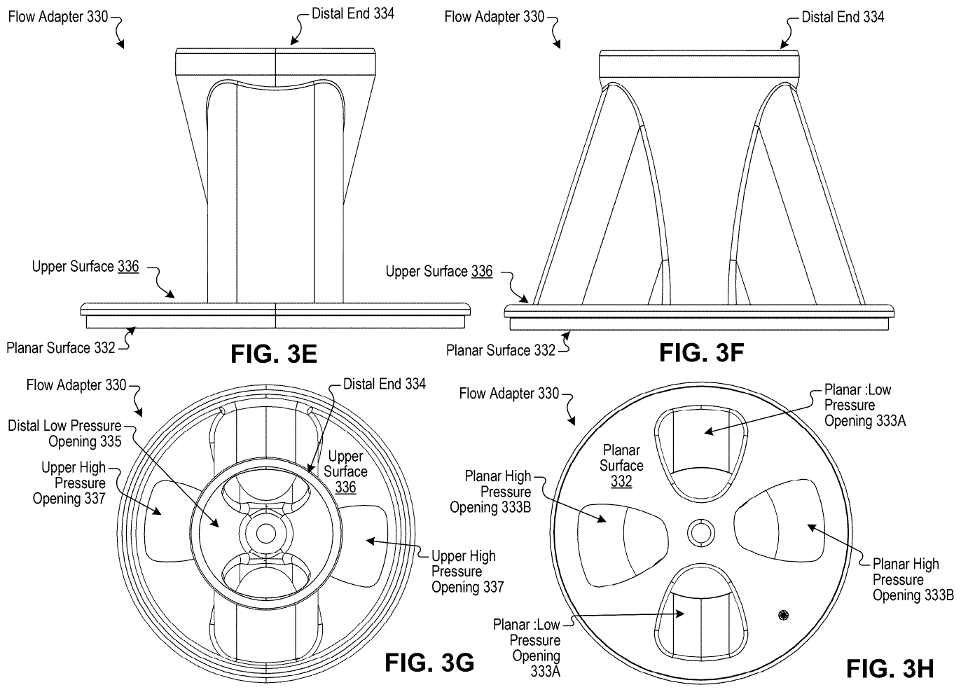

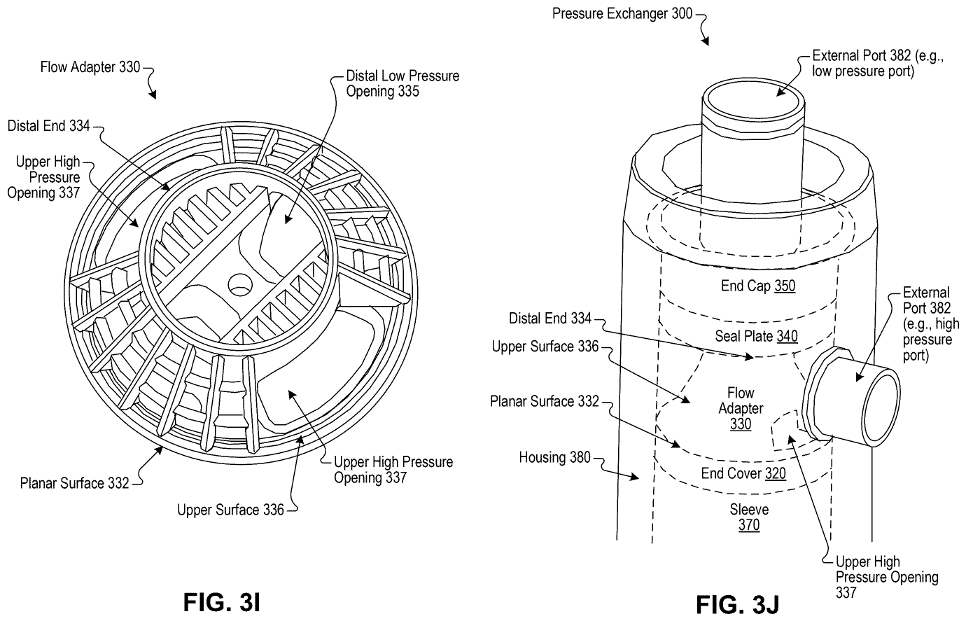

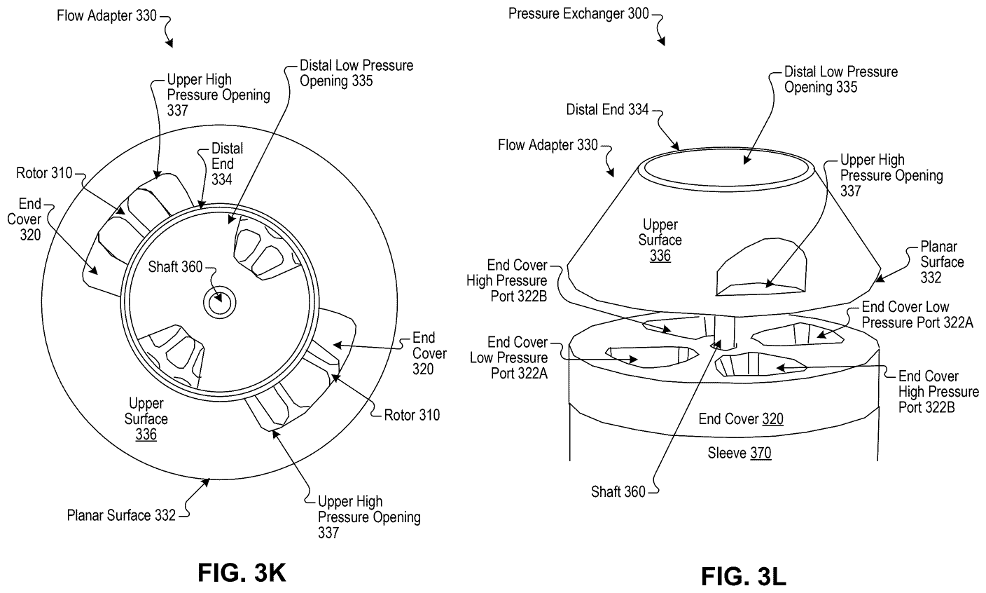

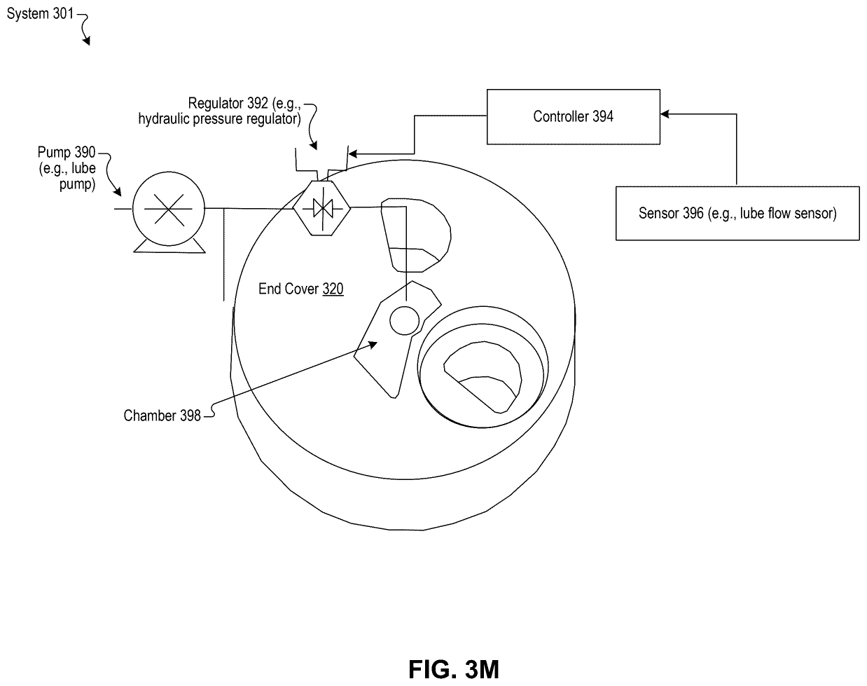

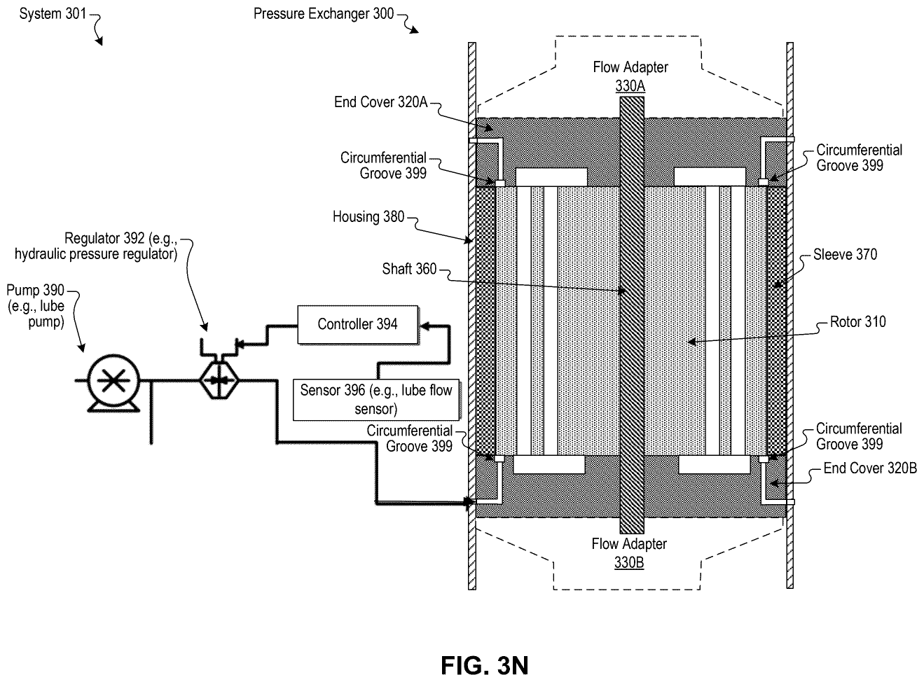

In some embodiments, a hydraulic energy transfer system 110 includes a pressure exchanger (e.g., PX). The PX may include one or more of the features described in one or more of FIGS. 3A-5 (e.g., flow adapter, etc.) to provide improved performance compared to conventional systems.

The hydraulic energy transfer system 110 (e.g., PX) receives low pressure (LP) fluid in 120 (e.g., low-pressure inlet stream) from a LP in system 122. The hydraulic energy transfer system 110 also receives high pressure (HP) fluid in 130 (e.g., high-pressure inlet stream) from HP in system 132. The hydraulic energy transfer system 110 (e.g., PX) exchanges pressure between the HP fluid in 130 and the LP fluid in 120 to provide LP fluid out 140 (e.g., low-pressure outlet stream) to LP fluid out system 142 and to provide HP fluid out 150 (e.g., high-pressure outlet stream) to HP fluid out system 152.

In some embodiments, the hydraulic energy transfer system 110 includes a PX to exchange pressure between the HP fluid in 130 and the LP fluid in 120. The PX may be a device that transfers fluid pressure between HP fluid in 130 and LP fluid in 120 at efficiencies in excess of approximately 50%, 60%, 70%, 80%, 90%, or greater (e.g., without utilizing centrifugal technology). High pressure (e.g., HP fluid in 130, HP fluid out 150) refers to pressures greater than the low pressure (e.g., LP fluid in 120, LP fluid out 140). LP fluid in 120 of the PX may be pressurized and exit the PX at high pressure (e.g., HP fluid out 150, at a pressure greater than that of LP fluid in 120), and HP fluid in 130 may be depressurized and exit the PX at low pressure (e.g., LP fluid out 140, at a pressure less than that of the HP fluid in 130). The PX may operate with the HP fluid in 130 directly applying a force to pressurize the LP fluid in 120, with or without a fluid separator between the fluids. Examples of fluid separators that may be used with the PX include, but are not limited to, pistons, bladders, diaphragms, and the like. In some embodiments, PXs may be rotary devices. Rotary PXs, such as those manufactured by Energy Recovery, Inc. of San Leandro, Calif., may not have any separate valves, since the effective valving action is accomplished internal to the device via the relative motion of a rotor with respect to end covers. Rotary PXs may be designed to operate with internal pistons to isolate fluids and transfer pressure with relatively little mixing of the inlet fluid streams. Reciprocating PXs may include a piston moving back and forth in a cylinder for transferring pressure between the fluid streams. Any PX or multiple PXs may be used in the present disclosure, such as, but not limited to, rotary PXs, reciprocating PXs, or any combination thereof. In addition, the PX may be disposed on a skid separate from the other components of a fluid handling system 100 (e.g., in situations in which the PX is added to an existing fluid handling system).

In some embodiments, a motor 160 is coupled to hydraulic energy transfer system 110 (e.g., to a PX). In some embodiments, the motor 160 controls the speed of a rotor of the hydraulic energy transfer system 110 (e.g., to increase pressure of HP fluid out 150, to decrease pressure of LP fluid out 140, etc.). In some embodiments, motor 160 generates energy (e.g., acts as a generator) based on pressure exchanging in hydraulic energy transfer system 110.

The hydraulic energy transfer system 110 may be a hydraulic protection system (e.g., hydraulic buffer system, hydraulic isolation system) that may block or limit contact between solid particle laden fluid (e.g., frac fluid) and various equipment (e.g., hydraulic fracturing equipment, high-pressure pumps) while exchanging work and/or pressure with another fluid. By blocking or limiting contact between various equipment (e.g., fracturing equipment) and solid particle containing fluid, the hydraulic energy transfer system 110 increases the life and performance, while reducing abrasion and wear, of various equipment (e.g., fracturing equipment, high pressure fluid pumps). Less expensive equipment may be used in the fluid handling system 100 by using equipment (e.g., high pressure fluid pumps) not designed for abrasive fluids (e.g., frac fluids and/or corrosive fluids).

The hydraulic energy transfer system 110 may include a hydraulic turbocharger or hydraulic pressure exchange system, such as a rotating PX. The PX may include one or more chambers (e.g., 1 to 100) to facilitate pressure transfer and equalization of pressures between volumes of first and second fluids (e.g., gas, liquid, multi-phase fluid). In some embodiments, the PX may transfer pressure between a first fluid (e.g., pressure exchange fluid, such as a proppant free or substantially proppant free fluid) and a second fluid that may be highly viscous and/or contain solid particles (e.g., frac fluid containing sand, proppant, powders, debris, ceramics). The solid particle fluid causes abrasion and/or erosion of components of the PX, such as the rotor and end covers of the PX. The fluid (e.g., abrasive particles in the fluid) may cause wear to an interface between the rotor and each end cover as the rotor rotates relative to the end covers. Replacing worn components of the PX may be costly.

The hydraulic energy transfer system 110 may be used in different types of systems, such as fracing systems, desalination systems, refrigeration systems, etc.

FIG. 1A illustrates a schematic diagram of a fluid handling system 100A including a hydraulic energy transfer system 110, according to certain embodiments. Fluid handling system 100A may include a control module 180 that includes one or more controllers 185.

FIG. 1B illustrates a schematic diagram of a fluid handling system 100B including a hydraulic energy transfer system 110, according to certain embodiments. Fluid handling system 100B may be a fracing system. In some embodiments, fluid handling system 100B includes more components, less components, same routing, different routing, and/or the like than that shown in FIG. 1B.

LP fluid in 120 and HP fluid out 150 may be frac fluid (e.g., fluid including solid particles, proppant fluid, etc.). HP fluid in 130 and LP fluid out 140 may be substantially solid particle free fluid (e.g., proppant free fluid, water, filtered fluid, etc.).

LP in system 122 may include one or more low pressure fluid pumps to provide LP fluid in 120 to the hydraulic energy transfer system 110 (e.g., PX). HP in system 132 may include one or more high pressure fluid pumps 134 to provide HP fluid in 130 to hydraulic energy transfer system 110.

Hydraulic energy transfer system 110 exchanges pressure between LP fluid in 120 (e.g., low pressure frac fluid) and HP fluid in 130 (e.g., high pressure water) to provide HP fluid out 150 (e.g., high pressure frac fluid) to HP out system 152 and to provide LP fluid out 140 (e.g., low pressure water). HP out system 152 may include a rock formation 154 (e.g., well) that includes cracks 156. The solid particles (e.g., proppants) from HP fluid out 150 may be provided into the cracks 156 of the rock formation.

In some embodiments, LP fluid out 140, high pressure fluid pumps 134, and HP fluid in 130 are part of a first loop (e.g., proppant free fluid loop). The LP fluid out 140 may be provided to the high pressure fluid pumps to generate HP fluid in 130 that becomes LP fluid out 140 upon exiting the hydraulic energy transfer system 110.

In some embodiments, LP fluid in 120, HP fluid out 150, and low pressure fluid pumps 124 are part of a second loop (e.g., proppant containing fluid loop). The HP fluid out 150 may be provided into the rock formation 154 and then pumped from the rock formation 154 by the low pressure fluid pumps 124 to generate LP fluid in 120.

In some embodiments, fluid handling system 100B is used in well completion operations in the oil and gas industry to perform hydraulic fracturing (e.g., fracking, fracing) to increase the release of oil and gas in rock formations 154. HP out system 152 may include rock formations 154 (e.g., a well). Hydraulic fracturing may include pumping HP fluid out 150 containing a combination of water, chemicals, and solid particles (e.g., sand, ceramics, proppant) into a well (e.g., rock formation 154) at high pressures. LP fluid in 120 and HP fluid out 150 may include a particulate laden fluid that increases the release of oil and gas in rock formations 154 by propagating and increasing the size of cracks 156 in the rock formations 154. The high pressures of HP fluid out 150 initiates and increases size of cracks 156 and propagation through the rock formation 154 to release more oil and gas, while the solid particles (e.g., powders, debris, etc.) enter the cracks 156 to keep the cracks 156 open (e.g., prevent the cracks 156 from closing once HP fluid out 150 is depressurized).

In order to pump this particulate laden fluid into the rock formation 154 (e.g., a well), the fluid handling system 100B may include one or more high pressure fluid pumps 134 and one or more low pressure fluid pumps 124 coupled to the hydraulic energy transfer system 110. For example, the hydraulic energy transfer system 110 may be a hydraulic turbocharger or a PX (e.g., a rotary PX). In operation, the hydraulic energy transfer system 110 transfers pressures without any substantial mixing between a first fluid (e.g., HP fluid in 130, proppant free fluid) pumped by the high pressure fluid pumps 134 and a second fluid (e.g., LP fluid in 120, proppant containing fluid, frac fluid) pumped by the low pressure fluid pumps 124. In this manner, the hydraulic energy transfer system 110 blocks or limits wear on the high pressure fluid pumps 134, while enabling the fluid handling system 100B to pump a high-pressure frac fluid (e.g., HP fluid out 150) into the rock formation 154 to release oil and gas. In order to operate in corrosive and abrasive environments, the hydraulic energy transfer system 110 may be made from materials resistant to corrosive and abrasive substances in either the first and second fluids. For example, the hydraulic energy transfer system 110 may be made out of ceramics (e.g., alumina, cermets, such as carbide, oxide, nitride, or boride hard phases) within a metal matrix (e.g., Co, Cr or Ni or any combination thereof) such as tungsten carbide in a matrix of CoCr, Ni, NiCr or Co.

In some embodiments, the hydraulic energy transfer system 110 includes a PX (e.g., rotary PX) and HP fluid in 130 (e.g., the first fluid, high-pressure solid particle free fluid) enters a first side of the PX where the HP fluid in 130 contacts LP fluid in 120 (e.g., the second fluid, low-pressure frac fluid) entering the PX on a second side. The contact between the fluids enables the HP fluid in 130 to increase the pressure of the second fluid (e.g., LP fluid in 120), which drives the second fluid out (e.g., HP fluid out 150) of the PX and down a well (e.g., rock formation 154) for fracturing operations. The first fluid (e.g., LP fluid out 140) similarly exits the PX, but at a low pressure after exchanging pressure with the second fluid. As noted above, the second fluid may be a low-pressure frac fluid that may include abrasive particles, which may wear the interface between the rotor and the respective end covers as the rotor rotates relative to the respective end covers.

FIG. 1C illustrates a schematic diagram of a fluid handling system 100C including a hydraulic energy transfer system 110, according to certain embodiments. Fluid handling system 100C may be a desalination system (e.g., remove salt and/or other minerals from water). In some embodiments, fluid handling system 100C includes more components, less components, same routing, different routing, and/or the like than that shown in FIG. 1C.

LP in system 122 may include a feed pump 126 (e.g., low pressure fluid pump 124) that receives seawater in 170 (e.g., feed water from a reservoir or directly from the ocean) and provides LP fluid in 120 (e.g., low pressure seawater, feed water) to hydraulic energy transfer system 110 (e.g., PX). HP in system 132 may include membranes 136 that provide HP fluid in 130 (e.g., high pressure brine) to hydraulic energy transfer system 110 (e.g., PX). The hydraulic energy transfer system 110 exchanges pressure between the HP fluid in 130 and LP fluid in 120 to provide HP fluid out 150 (e.g., high pressure seawater) to HP out system 152 and to provide LP fluid out 140 (e.g., low pressure brine) to LP out system 142 (e.g., geological mass, ocean, sea, discarded, etc.).

The membranes 136 may be a membrane separation device configured to separate fluids traversing a membrane, such as a reverse osmosis membrane. Membranes 136 may provide HP fluid in 130 which is a concentrated feed-water or concentrate (e.g., brine) to the hydraulic energy transfer system 110. Pressure of the HP fluid in 130 may be used to compress low-pressure feed water (e.g., LP fluid in 120) to be high pressure feed water (e.g., HP fluid out 150). For simplicity and illustration purposes, the term feed water is used. However, fluids other than water may be used in the hydraulic energy transfer system 110.

The circulation pump 158 (e.g., centrifugal pump) provides the HP fluid out 150 (e.g., high pressure seawater) to membranes 136. The membranes 136 filter the HP fluid out 150 to provide LP potable water 172 and HP fluid in 130 (e.g., high pressure brine). The LP out system 142 provides brine out 174 (e.g., to geological mass, ocean, sea, discarded, etc.).

In some embodiments, a high pressure fluid pump 176 is disposed between the feed pump 126 and the membranes 136. The high pressure fluid pump 176 increases pressure of the low pressure seawater (e.g., LP fluid in 120, provides high pressure feed water) to be mixed with the high pressure seawater provided by circulation pump 158.

In some embodiments, use of the hydraulic energy transfer system 110 decreases the load on high pressure fluid pump 176. In some embodiments, fluid handling system 100C provides LP potable water 172 without use of high pressure fluid pump 176. In some embodiments, fluid handling system 100C provides LP potable water 172 with intermittent use of high pressure fluid pump 176.

In some examples, hydraulic energy transfer system 110 (e.g., PX) receives LP fluid in 120 (e.g., low-pressure feed-water) at about 30 pounds per square inch (PSI) and receives HP fluid in 130 (e.g., high-pressure brine or concentrate) at about 980 PSI. The hydraulic energy transfer system 110 (e.g., PX) transfers pressure from the high-pressure concentrate (e.g., HP fluid in 130) to the low-pressure feed-water (e.g., LP fluid in 120). The hydraulic energy transfer system 110 (e.g., PX) outputs HP fluid out 150 (e.g., high pressure (compressed) feed-water) at about 965 PSI and LP fluid out 140 (e.g., low-pressure concentrate) at about 15 PSI. Thus, the hydraulic energy transfer system 110 (e.g., PX) may be about 97% efficient since the input volume is about equal to the output volume of the hydraulic energy transfer system 110 (e.g., PX), and 965 PSI is about 97% of 980 PSI.

FIG. 1D illustrates a schematic diagram of a fluid handling system 100D including a hydraulic energy transfer system 110, according to certain embodiments. Fluid handling system 100D may be a refrigeration system. In some embodiments, fluid handling system 100D includes more components, less components, same routing, different routing, and/or the like than that shown in FIG. 1D.

Hydraulic energy transfer system 110 (e.g., PX) may receive LP fluid in 120 from LP in system 122 (e.g., low pressure lift device 128, low pressure fluid pump, etc.) and HP fluid in 130 from HP in system 132 (e.g., condenser 138). The hydraulic energy transfer system 110 (e.g., PX) may exchange pressure between the LP fluid in 120 and HP fluid in 130 to provide HP fluid out 150 to HP out system 152 (e.g., high pressure lift device 159) and to provide LP fluid out 140 to LP out system 142 (e.g., evaporator 144). The evaporator 144 may provide the fluid to compressor 178 and low pressure lift device 128. The condenser 138 may receive fluid from compressor 178 and high pressure lift device 159.

The fluid handling system 100D may be a closed system. LP fluid in 120, HP fluid in 130, LP fluid out 140, and HP fluid out 150 may all be a fluid (e.g., refrigerant) that is circulated in the closed system of fluid handling system 100D.

In some embodiments, the fluid of fluid handling system 100D may include solid particles. For example, the piping, equipment, connections (e.g., pipe welds, pipe soldering), etc. may introduce solid particles (e.g., solid particles from the welds) into the fluid in the fluid handling system 100D. The solid particles in the fluid and/or the high pressure of the fluid may cause abrasion and/or erosion of components (e.g., rotor, end covers) of the PX of hydraulic energy transfer system 110.

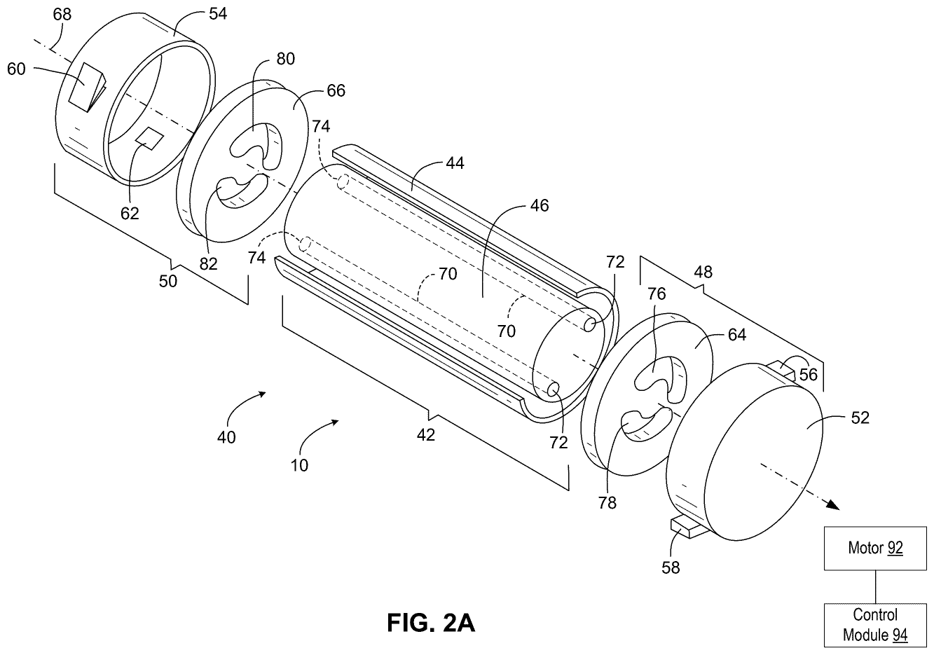

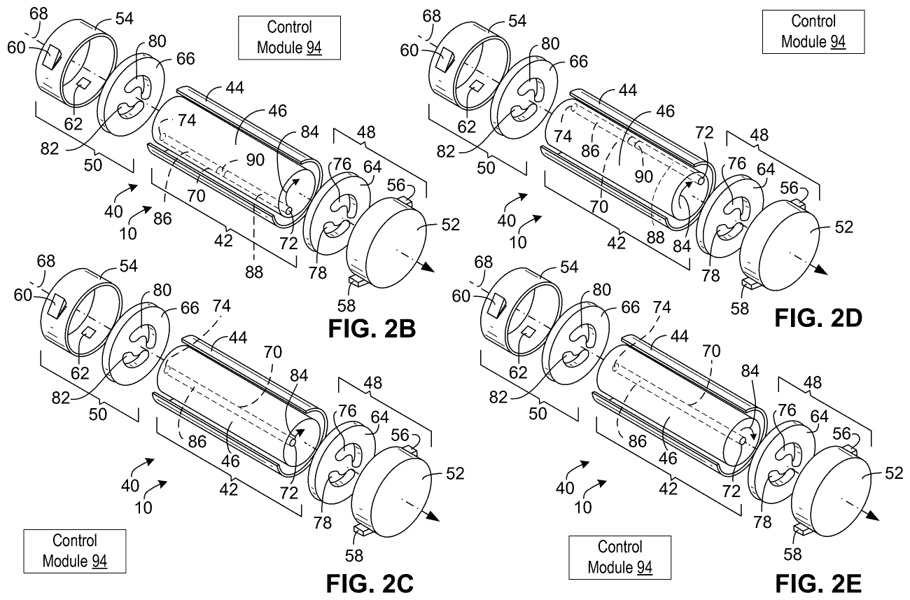

FIGS. 2A-E are exploded perspective views a rotary PX 40 (e.g., rotary pressure exchanger, rotary liquid piston compressor (LPC)), according to certain embodiments. PX 40 may include a motor 92 and/or a control module 94.

In some embodiments, PX 40 includes one or more of the features described in one or more of FIGS. 3A-5 (e.g., flow adapter, etc.) to provide improved performance compared to conventional systems.

PX 40 is configured to transfer pressure and/or work between a first fluid (e.g., proppant free fluid or supercritical carbon dioxide, HP fluid in 130) and a second fluid (e.g., frac fluid or superheated gaseous carbon dioxide, LP fluid in 120) with minimal mixing of the fluids. The rotary PX 40 may include a generally cylindrical body portion 42 that includes a sleeve 44 (e.g., rotor sleeve) and a rotor 46. The rotary PX 40 may also include two end caps 48 and 50 that include manifolds 52 and 54, respectively. Manifold 52 includes respective inlet port 56 and outlet port 58, while manifold 54 includes respective inlet port 60 and outlet port 62. In operation, these inlet ports 56, 60 enable the first and second fluids to enter the rotary PX 40 to exchange pressure, while the outlet ports 58, 62 enable the first and second fluids to then exit the rotary PX 40. In operation, the inlet port 56 may receive a high-pressure first fluid (e.g., HP fluid in 130), and after exchanging pressure, the outlet port 58 may be used to route a low-pressure first fluid (e.g., LP fluid out 140) out of the rotary PX 40. Similarly, the inlet port 60 may receive a low-pressure second fluid (e.g., LP fluid in 120) and the outlet port 62 may be used to route a high-pressure second fluid (e.g., HP fluid out 150) out of the rotary PX 40. The end caps 48 and 50 include respective end covers 64 and 66 (e.g., end plates) disposed within respective manifolds 52 and 54 that enable fluid sealing contact with the rotor 46.

As noted above, one or more components of the PX 40, such as the rotor 46, the end cover 64, and/or the end cover 66, may be constructed from a wear-resistant material (e.g., carbide, cemented carbide, silicon carbide, tungsten carbide, etc.) with a hardness greater than a predetermined threshold (e.g., a Vickers hardness number that is at least 1000, 1250, 1500, 1750, 2000, 2250, or more). For example, tungsten carbide may be more durable and may provide improved wear resistance to abrasive fluids as compared to other materials, such as alumina ceramics.

The rotor 46 may be cylindrical and disposed in the sleeve 44, which enables the rotor 46 to rotate about the axis 68. The rotor 46 may have a plurality of channels 70 (e.g., ducts, rotor ducts) extending substantially longitudinally through the rotor 46 with openings 72 and 74 (e.g., rotor ports) at each end arranged symmetrically about the longitudinal axis 68. The openings 72 and 74 of the rotor 46 are arranged for hydraulic communication with inlet and outlet apertures 76 and 78 (e.g., end cover inlet port and end cover outlet port) and 80 and 82 (e.g., end cover inlet port and end cover outlet port) in the end covers 64 and 66, in such a manner that during rotation the channels 70 are exposed to fluid at high-pressure and fluid at low-pressure. As illustrated, the inlet and outlet apertures 76 and 78 and 80 and 82 may be designed in the form of arcs or segments of a circle (e.g., C-shaped).

In some embodiments, a controller using sensor feedback (e.g., revolutions per minute measured through a tachometer or optical encoder or volume flow rate measured through flowmeter) may control the extent of mixing between the first and second fluids in the rotary PX 40, which may be used to improve the operability of the fluid handling system (e.g., fluid handling systems 100A-D of FIGS. 1A-D). For example, varying the volume flow rates of the first and second fluids entering the rotary PX 40 allows the plant operator (e.g., system operator) to control the amount of fluid mixing within the PX 40. In addition, varying the rotational speed of the rotor 46 also allows the operator to control mixing. Three characteristics of the rotary PX 40 that affect mixing are: (1) the aspect ratio of the rotor channels 70; (2) the duration of exposure between the first and second fluids; and (3) the creation of a fluid barrier (e.g., an interface) between the first and second fluids within the rotor channels 70. First, the rotor channels 70 (e.g., ducts) are generally long and narrow, which stabilizes the flow within the rotary PX 40. In addition, the first and second fluids may move through the channels 70 in a plug flow regime with minimal axial mixing. Second, in certain embodiments, the speed of the rotor 46 reduces contact between the first and second fluids. For example, the speed of the rotor 46 (e.g., rotor speed of approximately 1200 RPM) may reduce contact times between the first and second fluids to less than approximately 0.15 seconds, 0.10 seconds, or 0.05 seconds. Third, a small portion of the rotor channel 70 is used for the exchange of pressure between the first and second fluids. Therefore, a volume of fluid remains in the channel 70 as a barrier between the first and second fluids. All these mechanisms may limit mixing within the rotary PX 40. Moreover, in some embodiments, the rotary PX 40 may be designed to operate with internal pistons or other barriers, either complete or partial, that isolate the first and second fluids while enabling pressure transfer.

FIGS. 2B-2E are exploded views of an embodiment of the rotary PX 40 illustrating the sequence of positions of a single rotor channel 70 in the rotor 46 as the channel 70 rotates through a complete cycle. It is noted that FIGS. 2B-2E are simplifications of the rotary PX 40 showing one rotor channel 70, and the channel 70 is shown as having a circular cross-sectional shape. In other embodiments, the rotary PX 40 may include a plurality of channels 70 with the same or different cross-sectional shapes (e.g., circular, oval, square, rectangular, polygonal, etc.). Thus, FIGS. 2B-2E are simplifications for purposes of illustration, and other embodiments of the rotary PX 40 may have configurations different from that shown in FIGS. 2A-2E. As described in detail below, the rotary PX 40 facilitates pressure exchange between first and second fluids by enabling the first and second fluids to briefly contact each other within the rotor 46. In certain embodiments, this exchange happens at speeds that result in limited mixing of the first and second fluids. The speed of the pressure wave traveling through the rotor channel 70 (as soon as the channel is exposed to the aperture 76), the diffusion speeds of the fluids, and the rotational speed of rotor 46 dictate whether any mixing occurs and to what extent.

FIG. 2B is an exploded perspective view of an embodiment of a rotary PX 40 (e.g., rotary LPC), according to certain embodiments. In FIG. 2B, the channel opening 72 is in a first position. In the first position, the channel opening 72 is in fluid communication with the aperture 78 in end cover 64 and therefore with the manifold 52, while the opposing channel opening 74 is in hydraulic communication with the aperture 82 in end cover 66 and by extension with the manifold 54. As will be discussed below, the rotor 46 may rotate in the clockwise direction indicated by arrow 84. In operation, low-pressure second fluid 86 passes through end cover 66 and enters the channel 70, where it contacts the first fluid 88 at a dynamic fluid interface 90. The second fluid 86 then drives the first fluid 88 out of the channel 70, through end cover 64, and out of the rotary PX 40. However, because of the short duration of contact, there is minimal mixing between the second fluid 86 and the first fluid 88.

FIG. 2C is an exploded perspective view of an embodiment of a rotary PX 40 (e.g., rotary LPC), according to certain embodiments. In FIG. 2C, the channel 70 has rotated clockwise through an arc of approximately 90 degrees. In this position, the opening 74 (e.g., outlet) is no longer in fluid communication with the apertures 80 and 82 of end cover 66, and the opening 72 is no longer in fluid communication with the apertures 76 and 78 of end cover 64. Accordingly, the low-pressure second fluid 86 is temporarily contained within the channel 70.

FIG. 2D is an exploded perspective view of an embodiment of a rotary PX 40 (e.g., rotary LPC), according to certain embodiments. In FIG. 2D, the channel 70 has rotated through approximately 60 degrees of arc from the position shown in FIG. 2B. The opening 74 is now in fluid communication with aperture 80 in end cover 66, and the opening 72 of the channel 70 is now in fluid communication with aperture 76 of the end cover 64. In this position, high-pressure first fluid 88 enters and pressurizes the low-pressure second fluid 86, driving the second fluid 86 out of the rotor channel 70 and through the aperture 80.

FIG. 2E is an exploded perspective view of an embodiment of a rotary PX 40 (e.g., rotary LPC), according to certain embodiments. In FIG. 2E, the channel 70 has rotated through approximately 270 degrees of arc from the position shown in FIG. 2B. In this position, the opening 74 is no longer in fluid communication with the apertures 80 and 82 of end cover 66, and the opening 72 is no longer in fluid communication with the apertures 76 and 78 of end cover 64. Accordingly, the first fluid 88 is no longer pressurized and is temporarily contained within the channel 70 until the rotor 46 rotates another 90 degrees, starting the cycle over again.

Abrasion and/or erosion damage in a PX may occur when suspended solids are introduced and mixed in the fluid that enters the PX. Abrasion damage may occur when particles enter gaps in the PX (e.g., trapped between a stationary end cover and a rotating rotor). Erosion damage may occur due to existence of suspended solids (e.g., erodents) in high velocity fluid jets (e.g., slurry jets) that are formed due to the high pressure differentials inside the PX. When the high velocity jet makes an impact with components of the PX, the high velocity jet can cause damage to those components. Damage (e.g., erosion damage) can occur when a high pressure rotor port (e.g., rotor duct) opens to a low pressure end cover port (e.g., kidney) or when a low pressure rotor port (e.g., rotor duct) opens to a high pressure end cover port (e.g., kidney) which causes a high pressure differential.

FIGS. 3A-N illustrate components of PXs 300, according to some embodiments. Hydraulic energy transfer system 110 of one or more of FIGS. 1A-D and/or PX 40 of one or more of FIGS. 2A-E may include one or more features, materials, functionalities, etc. that are the same as or similar to those of FIGS. 3A-N. PXs 300 described in FIGS. 3A-N may include one or more features, materials, functionalities, etc. as described in relation to one or more of FIGS. 1A-2E.

FIG. 3A illustrates a front cross-sectional view of a PX 300 including a flow adapter 330 (e.g., adapter plate), according to certain embodiments. FIG. 3B illustrates a front perspective view of a flow adapter 330, according to certain embodiments. FIG. 3C illustrates a top perspective view of a flow adapter 330, according to certain embodiments. FIG. 3D illustrates a bottom perspective view of a flow adapter 330, according to certain embodiments. FIG. 3E illustrates a side view of a flow adapter 330, according to certain embodiments. FIG. 3F illustrates a front view of a flow adapter 330, according to certain embodiments. FIG. 3G illustrates a top view of a flow adapter 330, according to certain embodiments. FIG. 3H illustrates a bottom view of a flow adapter 330, according to certain embodiments. FIG. 3I illustrates a front perspective view of a PX 300, according to certain embodiments. FIG. 3J illustrates a front perspective view of a PX 300 including a flow adapter 330, according to certain embodiments. FIG. 3K illustrates a top view of a PX 300 including a flow adapter 330, according to certain embodiments. FIG. 3L illustrates a front perspective partially exploded view of a PX 300 including a flow adapter 330, according to certain embodiments.

Referring to FIG. 3A, a PX 300 may include a rotor 310, end covers 320A-B, flow adapters 330A-B, seal plates 340A-B, end caps 350A-B, shaft 360, sleeve 370, housing 380, and external ports 382 (e.g., low pressure ports and high pressure ports).

Rotor 310 may be configured to exchange pressure between a first fluid and a second fluid. End covers 320 may be disposed at distal ends of the rotor 310. Each end cover 320 forms one or more end cover low pressure ports 322A and one or more end cover high pressure ports 332B. In some embodiments, end cover 320 forms at least two low pressure ports and at least two high pressure ports (e.g., multi-cycle PX 300).

Flow adapter 330 may include planar surface 332, distal end 334, and upper surface 336. Planar surface 332 may form planar openings 333 (e.g., planar low pressure openings 333A and planar high pressure openings 333B). The planar surface 332 is configured to seal to the end cover 320 (e.g., via face seals 338, via radial seals). The distal end 334 forms a distal low pressure opening 335. Low pressure fluid flow is between the end cover low pressure ports 332A and the distal low pressure opening 335 via the planar low pressure openings 333A. Flow adapter 330 may form low pressure pathways from planar low pressure openings 333A that combine into a single pathway to distal low pressure opening 335. The upper surface 336 forms upper high pressure openings 337. Flow adapter 330 may form a high pressure pathway from planar high pressure opening 333B to a corresponding upper high pressure opening 337 (e.g., separate high pressure pathway for each planar high pressure opening 333B). High pressure fluid flow is between the end cover high pressure ports and the upper high pressure openings 337 via the planar high pressure openings 333B.

In some embodiments, the flow adapter 330 is configured to direct flow paths between the end cover 320 and external ports 382 (e.g., low pressure port and high pressure port) of the PX 300.

In some embodiments, the flow adapter 330 is configured to set pressure distribution on the end cover 320.

In some embodiments, the flow adapter 330 is configured to seal against the end cover 320 to provide a sealed pathway between the end cover 320 and external ports 382 (e.g., low pressure port and high pressure port) of the PX 300.

In some embodiments, the flow adapter 330 has a substantially uniform wall thickness (e.g., see FIGS. 3B-H). In some embodiments, the flow adapter is injection molded (e.g., has ribs to be substantially the same thickness, see FIG. 3I).

In some embodiments, the end cover 320 forms at least two low pressure ports 322A and at least two high pressure ports 322B. The flow adapter 330 is configured to combine fluid flow from the at least two low pressure ports 322A (e.g., at distal low pressure opening 335) and provides the combined fluid flow to a low pressure external port 382 (e.g., low pressure port).

In some embodiments, the flow adapter 330 combines fluid flow from the end cover low pressure ports 322A of the end cover 320 proximate a center of the end cover 320 to reduce deflection of the end cover 320 in relation to the rotor 310 (e.g., to reduce high pressure proximate the center of the end cover 320).

In some embodiments, the planar surface 332 of the flow adapter 330 is configured to seal to the end cover 320 via face seals 338 (e.g., gaskets, O-rings, etc.) or radial seals.

In some embodiments, the flow adapter 330 includes an over molded structure (e.g., an over molded steel structure or an over molded ceramic structure).

In some embodiments, flow adapter 330 is an interface between PX cartridge (e.g., rotor 310, end covers 320, and sleeve 370) and housing (e.g., seal plate 340, housing 380, end cap 350, etc.) to direct flow paths and set pressure distribution.

The PX cartridge (e.g., rotor 310, sleeve 370, and two end covers 320 which dictate HP and LP flows into rotor 310) is to have a sealed pathway (e.g., via flow adapter 330) to route HP and LP flows into the end cover 320 from the housing 380 and external ports 382 (e.g., low pressure port and high pressure port). Flow adapter 330 provides a sealed pathway that has performance and cost advantages and increases design flexibility compared to conventional solutions.

The flow adapter 330 is sealed to the back of the end cover 320 (e.g., surface of the end cover 320 opposite the end cover surface proximate the rotor 310). Flow adapter 330 combines fluid flow from LP ports and routes the fluid flow from the LP ports (e.g., to the low pressure external port 382). Flow adapter 330 combines fluid flow from HP ports and routes the fluid flow from the HP ports (e.g., to the high pressure external port 382).

Flow adapter 330 may avoid costly machining of (e.g., forming bores in) ceramic end covers 320. The complex geometry may be moved from conventional end covers to the flow adapter 330 (e.g., cheaper to produce flow adapter 330 with complex geometries via injection molding instead of machining complex geometries into a ceramic end cover).

In some embodiments, end cover 320 has two HP ports and two LP ports (e.g., may have more or less than two of each of HP ports and LP ports). The flow adapter 330 seals to the backside of the end cover 320. The geometry of the flow adapter 330 combines LP with LP flows and combines HP with HP flows and seals between them (e.g., prevents LP fluid flow from mixing with HP fluid flow).

In some embodiments, the two LP ports of the end cover 320 are combined towards the center/inside portion of the flow adapter 330 and the HP ports are combined on the outside portion of the flow adapter 330. By combining the LP fluid towards the center of the flow adapter 330, this allows reduction of the amount of pressure force on the center of the end cover 320. This may reduce the deflection of the end cover 320 towards the rotor 310.

By changing the diameter of the LP outlet port at the top (e.g., distal end 334) of the flow adapter 330, the amount of pressure on the end covers 320 can be varied.

PX 300 that includes a flow adapter 330 may avoid using interconnects and bores that are machined into the back of end covers in conventional systems. Interconnects and bore machining increases costs of conventional systems. The bores may also take up a lot of space in the end cover in conventional systems. By using a flow adapter 330 (e.g., and face seals 338 and/or radial seals), PX 300 may have a smoother flow path with more flexibility of how the path is formed through the end cover 320.

In some embodiments, complex geometry is moved to the flow adapter 330 which allows for simplification of the end cover 320.

Flow adapter 330 allows for greater design flexibility (e.g., accommodation for interconnect bores may no longer be needed) and ports of end covers 320 may be located closer to the outside diameter (e.g., of end cover 320). This may enable PX 300 to have a center post design (e.g., sleeveless design).

Over molded features (e.g., steel or ceramic) can be enveloped by the flow adapter 330 to increase strength and stiffness where needed. In some embodiments, use of flow adapter 330 may enable a PX that has a thin (e.g., very thin) end cover 320 compared to conventional solutions. Conventionally, an end cover 320 is made of a thick ceramic (e.g., stiff, low deflection, good bearing material). With use of a flow adapter 330 to have a properly pressure-balanced design (e.g., equal pressure forces from front to backside of end cover 320), the end cover 320 can become thinner and thinner to a point where the end cover 320 may be a thin slab with all of the intricate flow geometry and sealing surfaces molded into the flow adapter 330 or the flow adapter 330 can simply interface with the rotor 310 directly.

In some embodiments, flow adapter 330 may balance pressure distribution on end covers 320 which may minimize deflections (e.g., of end covers 320) and leakage (e.g., via interface between end cover 320 and rotor 310) leading to higher performance of PX 300.

The flow adapter 330 may be injection-molded to enable hydraulically smooth flow passages to minimize losses in difference in pressure (DP) and to enhance efficiency of PX 300.

In some embodiments, flow adapter 330 reduces and/or eliminates multiple expensive parts in PX design which results in cost, material, time, and waste reduction.

In some embodiments, flow adapter 330 is used for PX that has single cycle PX design (e.g., single LP port and single HP port in end cover 320) or multi-cycle PX design (e.g., two or more LP ports, two or more HP ports). In some embodiments, end cover 320 has a same number of LP ports as HP ports (e.g., two LP ports and two HP ports).

In some embodiments, flow adapter 330 is used in a sleeved PX. In some embodiments, flow adapter 330 is used in a sleeveless PX (e.g., center post PX).

Flow adapter 330 may simplify design of end cover 320 and may reduce manufacturing complexity of end cover 320.

Flow adapter 330 may be used to reduce height, weight, and/or footprint of PX 300.

In some embodiments, flow adapter 330 is made out of metal (e.g., aluminum, steel, etc.). In some embodiments, flow adapter 330 is made out of plastic (e.g., injection molded plastic).

In some embodiments, flow adapter 330 is configured to distribute the high pressure and low pressure areas on the back side of the end cover 320 in a certain proportion to substantially match the pressure distribution on the front side of the end cover 320 facing the rotor 310. In some embodiments, this is done by using grooves and gaskets (e.g., O-rings) in the grooves at the interface between the flow adapter 330 and the end cover 320 (e.g., planar surface 332 of flow adapter 330 forms grooves and the gaskets are disposed in the grooves, end cover surface proximate flow adapter 330 forms grooves and the gaskets are disposed in the grooves). This minimizes end cover deflections in the axial direction which avoids using large axial bearing clearances (e.g., between rotor 310 and end cover 320) to accommodate end cover deflections. Shorter and spatially uniform axial bearing clearances may allow lower leakage and higher PX efficiency. Mixing through bearing gaps may also be reduced.

FIGS. 3M-N illustrate systems 301 including PXs 300, according to certain embodiments. Systems 301 may include pump 390 (e.g., lube pump), regulator 392 (e.g., hydraulic pressure regulator), controller 394, and sensor 396 (e.g., lube flow sensor).

This pressure distribution may work well via flow adapter 330 (e.g., flow adapter 330 configured to passively control pressure of the end cover 320) when the PX 300 is configured to operate at one condition. This may not always be the case and the HP/LP pressure differential may change resulting in a different pressure distribution and the interface between end cover 320 and rotor 310. The center bore pressure may change either by design (e.g., switching center bore fluid source due to fluid composition or other specifications) or naturally over time due to wear, erosion, deposits in the pressure equalization channel, etc. Similarly, circumferential groove pressure can change either by design (e.g., external bearing fluid supply) or naturally due to fouling, wear, etc.

In some embodiments, an active end cover pressure balance system is used to match the changing pressure distribution on the rotor end face of the end cover 320. This way, end cover deflections continue to be controlled resulting in optimal flow (e.g., optimal leakage flow). This may be accomplished by creating a chamber 398 (e.g., area, volume surrounded by gasket, etc.) between the flow adapter 330 and end cover 320, the pressure inside which is regulated by a regulator 392 (e.g., hydraulic pressure regulator) driven by a controller 394 (e.g., see FIG. 3M). A pump 390 (e.g., lube pump) or a pressurized fluid source may be connected to the channel through a regulator 392 (e.g., hydraulic pressure regulator). A controller 394 senses (e.g., via sensor data from sensor 396) the lube flow (e.g., leakage plus compressibility loss) of the PX 300 and adjusts the regulator 392 (e.g., hydraulic pressure regulator). Adjusting the regulator 392 causes adjustment of pressure in chamber 398 which in turn adjusts the end cover deflection which brings lube flow back within limits (e.g., to allow optimal performance).

Another common source of increased lube flow may be the axial eccentricity of the rotor 310. A rotor 310 that is not centered axially may have higher (e.g., much higher) lube flow compared to a well-centered rotor 310. Even if the rotor 310 and end covers 320 are configured to provide near zero axial thrust on the rotor 310 at the design point and the axial bearings are designed to provide adequate stiffness, rotor eccentricity can still arise. Rotor axial eccentricity can arise due to unequal pressure differential across the rotor 310 on HP and LP sides during operation. Eccentricity can also arise due to the changing operating conditions, fouled bearings, center bore pressure change, etc. To overcome this, an active rotor balancing system (e.g., of FIG. 3N) can be used.

Referring to FIG. 3N, system 301 can include an active rotor balancing system. Pressure inside one or more circumferential grooves 399 can be tuned using a regulator 392 (e.g., hydraulic pressure regulator) to axially center the rotor 310 (e.g., see FIG. 3N). A controller 394 senses (e.g., via sensor data from sensor 396) the increased lube flow (e.g., above a threshold) and adjusts the pressures in one or more of the circumferential grooves 399 (e.g., changes rotor thrust and bearing stiffness) to bring the rotor 310 back to a centered position and bring the lube flow within limits.

The present disclosure may be configured to enable the application of a pressure exchanger in a refrigeration system (e.g., transcritical carbon dioxide (CO2) refrigeration system). However, the present disclosure may be used in any application of a pressure exchanger in any field.

The present disclosure may enable the use of gaseous or multi-phase fluids at high pressures and/or high velocities in the pressure exchanger by providing a flow adapter 330.

The present disclosure (e.g., one or more embodiments of FIGS. 3A-N) may have improvement in one or more of pressure range, efficiency, reduction in volume and cost, etc. compared to conventional solutions.

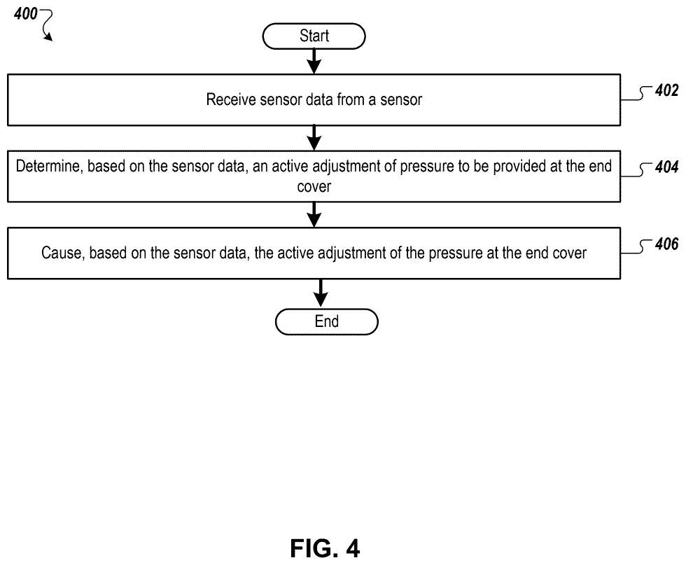

FIG. 4 is a flow diagram illustrating a method 400 associated with control of pressure in a pressure exchanger (e.g., PX 300 of one or more of FIGS. 3A-N), according to certain embodiments. In some embodiments, method 400 is performed by processing logic that includes hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiments, method 400 is performed, at least in part, by a controller (e.g., of control module 180 or controllers 185 of FIGS. 1A-D, control module 94 of FIGS. 2A-E, controller 394 of FIGS. 3M-N). In some embodiments, a non-transitory storage medium stores instructions that when executed by a processing device (e.g., of control module 180 or controllers 185 of FIGS. 1A-D, control module 94 of FIGS. 2A-E, controller 394 of FIGS. 3M-N), cause the processing device to perform method 400.

For simplicity of explanation, method 400 is depicted and described as a series of operations. However, operations in accordance with this disclosure can occur in various orders and/or concurrently and with other operations not presented and described herein. Furthermore, in some embodiments, not all illustrated operations are performed to implement method 400 in accordance with the disclosed subject matter. In addition, those skilled in the art will understand and appreciate that method 400 could alternatively be represented as a series of interrelated states via a state diagram or events.

At block 402, processing logic (e.g., controller) receives, from a sensor, sensor data. The sensor data may be pressure data between the end cover and the flow adapter or between the end cover and the rotor. In some embodiments, the sensor data may be the lube flow rate (e.g., flow rate differential between HPIN and HPOUT) of the PX.

At block 404, processing logic determines, based on the sensor data, an active adjustment of pressure to be provided at the end cover. The active adjustment may be increasing or decreasing the pressure at between the end cover and the flow adapter or between the end cover and the rotor.

At block 406, processing logic causes, based on the sensor data, the active adjustment of the pressure at the end cover. The processing logic may periodically repeat method 400.

In some embodiments, the processing logic is to cause the active adjustment of the pressure via lube pump (e.g., adjusting pressure between the flow adapter 330 and end cover 320). In some embodiments, the processing logic is to cause the active adjustment of the pressure at a surface of the end cover (e.g., between the end cover and the adapter plate, between the end cover and the rotor). In some embodiments, the processing logic is to cause the active adjustment of the pressure at a circumferential grove between the rotor and the end cover.

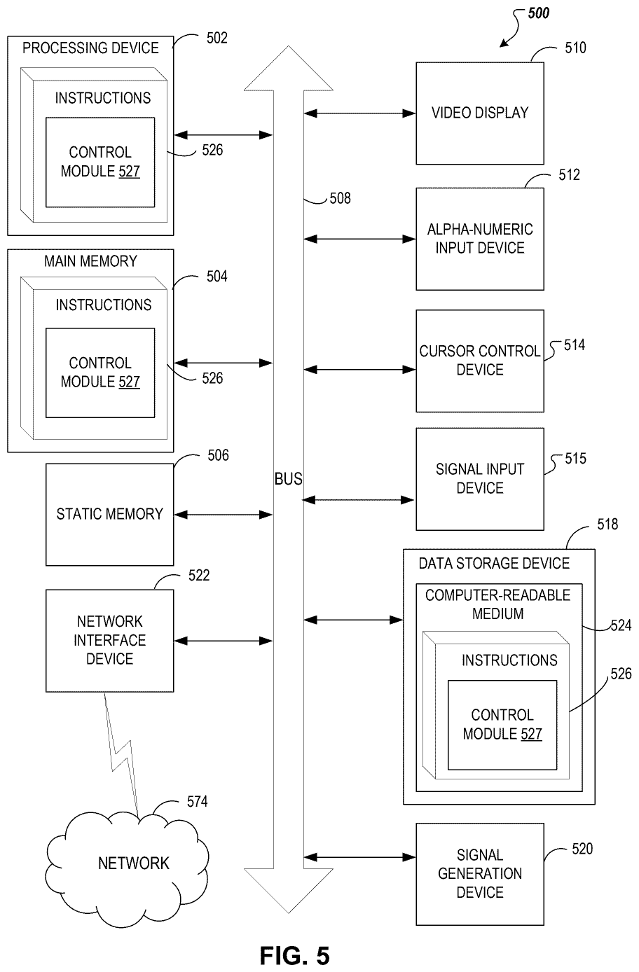

FIG. 5 is a block diagram illustrating a computer system 500, according to some embodiments. In some embodiments, the computer system 500 is a controller, controller device, client device, server, control module 180 or controllers 185 of FIGS. 1A-D, control module 94 of FIGS. 2A-E, controller 394 of FIGS. 3M-N, etc.

In some embodiments, computer system 500 is connected (e.g., via a network, such as a Local Area Network (LAN), an intranet, an extranet, or the Internet) to other computer systems. Computer system 500 operates in the capacity of a server or a client computer in a client-server environment, or as a peer computer in a peer-to-peer or distributed network environment. In some embodiments, computer system 500 is provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In some embodiments, the computer system 500 includes a processing device 502, a volatile memory 504 (e.g., Random Access Memory (RAM)), a non-volatile memory 506 (e.g., Read-Only Memory (ROM) or Electrically-Erasable Programmable ROM (EEPROM)), and/or a data storage device 516, which communicates with each other via a bus 508.

In some embodiments, processing device 502 is provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), a PID controller, or a network processor). In some embodiments, processing device 502 is provided by one or more of a single processor, multiple processors, a single processor having multiple processing cores, and/or the like.

In some embodiments, computer system 500 further includes a network interface device 522 (e.g., coupled to network 574). In some embodiments, the computer system 500 includes one or more input/output (I/O) devices. In some embodiments, computer system 500 also includes a video display unit 510 (e.g., a liquid crystal display (LCD)), an alphanumeric input device 512 (e.g., a keyboard), a cursor control device 514 (e.g., a mouse), and/or a signal generation device 520. Computer system 500 may include signal input device 515, e.g., for receiving signals from other devices. For example, signal input device 515 may facilitate reception by computer system 500 of measurement data from sensors associated with a fluid handling system. Signal generate device 520 may be utilized to generate and/or send control signals for sending instructions to one or more components of a fluid handling system.

In some implementations, data storage device 518 (e.g., disk drive storage, fixed and/or removable storage devices, fixed disk drive, removable memory card, optical storage, network attached storage (NAS), and/or storage area-network (SAN)) includes a non-transitory computer-readable storage medium 524 on which stores instructions 526 encoding any one or more of the methods or functions described herein, and for implementing methods described herein. Control module 527 (e.g., including any of controllers and/or control modules of the present disclosure) may be included in instructions 526.

In some embodiments, instructions 526 also reside, completely or partially, within volatile memory 504 and/or within processing device 502 during execution thereof by computer system 500, hence, volatile memory 504 and processing device 502 also constitute machine-readable storage media, in some embodiments.

While computer-readable storage medium 524 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs, or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise or clear from context, terms such as “receiving,” “transmitting,” “determining,” “generating,” “causing,” “actuating,” “adjusting,” “controlling,” “identifying,” “providing,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may include a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods described herein and/or each of their individual functions, routines, subroutines, or operations. Examples of the structure for a variety of these systems are set forth in the description above.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

The preceding description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure. Descriptions of systems herein may include descriptions of one or more optional components. Components may be included in combinations not specifically discussed in this disclosure, and still be within the scope of this disclosure.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about,” “substantially,” or “approximately” is used herein, this is intended to mean that the nominal value presented is precise within ±10%. Also, the terms “first,” “second,” “third,” “fourth,” etc. as used herein are meant as labels to distinguish among different elements and can not necessarily have an ordinal meaning according to their numerical designation.

The terms “over,” “under,” “between,” “disposed on,” “before,” “after,” and “on” as used herein refer to a relative position of one material layer or component with respect to other layers or components. For example, one layer disposed on, over, or under another layer may be directly in contact with the other layer or may have one or more intervening layers. Moreover, one layer disposed between two layers may be directly in contact with the two layers or may have one or more intervening layers. Similarly, unless explicitly stated otherwise, one feature disposed between two features may be in direct contact with the adjacent features or may have one or more intervening layers or components.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which each claim is entitled.

What is claimed is:

1. A pressure exchanger comprising:
a rotor configured to exchange pressure between a first fluid and a second fluid;
an end cover disposed at a first distal end of the rotor, the end cover forming end cover low pressure ports and end cover high pressure ports; and
a flow adapter comprising:
a planar surface forming planar low pressure openings and planar high pressure openings, wherein the planar surface is configured to seal to the end cover;
a distal end forming a distal low pressure opening, wherein low pressure fluid flow is between the end cover low pressure ports and the distal low pressure opening via the planar low pressure openings; and
an upper surface forming upper high pressure openings, wherein high pressure fluid flow is between the end cover high pressure ports and the upper high pressure openings via the planar high pressure openings.

2. The pressure exchanger of claim 1, wherein the flow adapter is configured to direct flow paths between the end cover and external ports of the pressure exchanger.

3. The pressure exchanger of claim 1, wherein the flow adapter is configured to set pressure distribution on the end cover to reduce deflection of the end cover in relation to the rotor.

4. The pressure exchanger of claim 1, wherein the flow adapter is configured to seal against the end cover to provide a sealed pathway between the end cover and external ports of the pressure exchanger.

5. The pressure exchanger of claim 1, wherein the flow adapter is injection molded.

6. The pressure exchanger of claim 1, wherein the end cover forms at least two low pressure ports and at least two high pressure ports, wherein the flow adapter is configured to combine fluid flow from the at least two low pressure ports and provides the combined fluid flow to a low pressure external port.

7. The pressure exchanger of claim 1, wherein the flow adapter combines fluid flow from the end cover low pressure ports of the end cover proximate a center of the end cover to reduce deflection of the end cover in relation to the rotor.

8. The pressure exchanger of claim 1, wherein the planar surface of the flow adapter is configured to seal to the end cover via face seals or radial seals.

9. The pressure exchanger of claim 1, wherein the flow adapter comprises an over molded steel structure or an over molded ceramic structure.

10. A flow adapter of a pressure exchanger, the flow adapter comprising:
a planar surface forming planar low pressure openings and planar high pressure openings, wherein face seals are to be disposed between the planar surface and an end cover to seal the flow adapter to the end cover, the end cover forming at least two end cover low pressure ports and at least two end cover high pressure ports;
a distal end forming a distal low pressure opening, wherein low pressure fluid flow is to be between the end cover low pressure ports and the distal low pressure opening via the planar low pressure openings; and
a upper surface forming upper high pressure openings, wherein high pressure fluid flow is between the end cover high pressure ports and the upper high pressure openings via the planar high pressure openings.

11. The flow adapter of claim 10, wherein the flow adapter is configured to direct flow paths between the end cover and external ports of the pressure exchanger.

12. The flow adapter of claim 10, wherein the flow adapter is configured to set pressure distribution on the end cover.

13. The flow adapter of claim 10, wherein the flow adapter is configured to seal against the end cover to provide a sealed pathway between the end cover and external ports of the pressure exchanger.

14. The flow adapter of claim 10, wherein the flow adapter is injection molded.

15. The flow adapter of claim 10, wherein the flow adapter is configured to combine fluid flow from the end cover low pressure ports of the end cover proximate a center of the end cover to reduce deflection of the end cover in relation to a rotor of the pressure exchanger.

16. The flow adapter of claim 10, wherein the flow adapter comprises an over molded steel structure or an over molded ceramic structure.

17. A system comprising:
a pressure exchanger comprising:
a rotor;
an end cover disposed at a distal end of the rotor; and
a flow adapter configured to passively control pressure at the end cover; and a controller configured to:
receive, from a lube flow sensor, sensor data; and
cause, based on the sensor data, active adjustment of the pressure at the end cover.

18. The system of claim 17, wherein the controller is to cause active adjustment of the pressure via a lube pump.

19. The system of claim 17, wherein the controller is to cause active adjustment of the pressure at a surface of the end cover.

20. The system of claim 17, wherein the controller is to cause active adjustment of the pressure at a circumferential groove between the rotor and the end cover.
